(19) United States
(12) Patent Application Publication
(10) Pub. No.: US 2022/0282976 A1
(43) Pub. Date: Sep. 8, 2022

(54) METHOD FOR DETERMINING A FLIGHT DISTANCE OF AN AIRCRAFT OVER A DISCONTINUITY SEGMENT, ASSOCIATED METHOD FOR DETERMINING A TRAJECTORY, COMPUTER PROGRAM PRODUCT AND DETERMINATION MODULE

(71) Applicant: THALES, Courbevoie (FR)

(72) Inventors: Johan BOYER, TOULOUSE (FR); Emmanuel DEWAS, TOULOUSE (FR); Geoffrey DURAND, Toulouse (FR)

(21) Appl. No.: 17/637,301

(22) PCT Filed: Aug. 21, 2020
(86) PCT No.: PCT/EP2020/073460

§ 371 Date: Feb. 22, 2022

(30) Foreign Application Priority Data
Aug. 22, 2019 (FR) 19 09342

(51) Int. Cl. G01C 21/20; G01C 21/00

(52) U.S. Cl. CPC G01C 21/20; G01C 21/005

(57) ABSTRACT

This method for determining a flight distance over a discontinuity segment comprises the steps of determining an altitude of entry to said trajectory portion and an altitude of exit from said trajectory portion, discretization of an altitude interval delimited by the altitude of entry and the altitude of exit into a plurality of elementary intervals, each elementary interval being defined using an elementary step and, for each elementary interval, determining an elementary slope of the aircraft.

This method further comprises a step of determining the flight distance over the discontinuity segment as a function of a direct distance between the framing segments, the elementary slopes, the elementary steps and the total extent of said trajectory portion.

### CROSS-REFERENCE TO RELATED APPLICATIONS

The present Application for Patent is a National Stage Entry of International Application PCT/EP2020/073460, filed Aug. 21, 2020, which claims priority to French Patent Application No. 19 09342, filed Aug. 22, 2019. The disclosures of the priority applications are incorporated in their entirety by reference herein.

### FIELD OF THE INVENTION

The present invention relates to a method for determining a flight distance of an aircraft over a segment of discontinuity.

This invention also concerns a method for determining a trajectory, a computer program product and a determination module.

In particular, the invention is situated in the field of flight management systems (FMS) for aircraft, and, more generally, systems for calculating the trajectories of aircraft.

### BACKGROUND OF THE INVENTION

As is known from the prior art, these systems allow for the construction of an aircraft trajectory based on a flight plan representing the contract between the airline and air traffic control. The trajectory based on this flight plan thus complies with a plurality of:
waypoints;
procedural constraints (legs), consisting of a ‘path/end’ pair;
transitional constraints (e.g. ‘overfly’ or ‘flyby’);
‘vertical’ constraints carried by the waypoints, which may relate to altitude, speed, slope, or time.

The trajectory calculated consists of a plurality of successive lateral ‘curve’ or ‘line’ segments and vertical segments, which may include acceleration/deceleration, constant speed, constant altitude, or variable altitude. The lateral and vertical segments are connected; thus, the vertical may segment the lateral, and vice versa.

The various types of legs, as well as the rules for their sequencing, are set forth, inter alia, by the standard ARINC 424.

Most of these legs define a starting point and an endpoint. Furthermore, vertical constraints may be defined on one or both of these points.

At least some of the legs may have no specified endpoints. In ARINC 424, this is the case, in particular, with the FM leg (Fix to a Manual termination) and the VM leg (Heading to a Manual termination). These legs are ‘manual’ or ‘manual termination’ legs, given that the end of such a leg is determined manually by the pilot while flying over the leg, e.g. following an instruction from air traffic control. The system inserts a lateral discontinuity following these legs, indicating that the remainder of the flight plan will only be followed after action by the pilot.

When the aircraft's flight plan includes a manual termination leg or another lateral discontinuity, the trajectory on which the aircraft must fly is not entirely known.

In the prior art, the solution generally used to address this issue is to assume a direct distance, i.e. the shortest distance to reach the next part of the flight plan, in calculating predictions.

This is shown in FIG. 1, in which a lateral discontinuity is formed between the segments DC and AB. Thus, in this case, in known-art methods, the shortest distance between these segments, i.e. the distance BC, will be taken into account when calculating predictions.

The use of such an assumption in current systems has several operational consequences.

First of all, it results in predictions that are erroneous in terms of the distance flown, which may, in turn, cause untimely alerts. Indeed, an altitude or speed constraint may fail to be announced downstream of the lateral discontinuity because the distance is too short for the necessary energy dissipation. This may generate an unfounded alert from the preparation of the flight, thus making this operation more complex.

Additionally, given the need to comply with the flight plan, this may make it necessary to begin losing energy for a landing much earlier than necessary. Indeed, an FMS system, calculating that the aircraft will not be able to decelerate along the lateral discontinuity if it is too steep, will begin deceleration before the aircraft arrives at the lateral discontinuity.

This operation runs counter to expectations given that, generally, the instructions given by controllers concerning the deselection of the manual termination leg allow for the necessary energy dissipation along this leg.

Moreover, this operation may result in premature extension of certain actuators such as slats and flaps. Because the calculation of altitude profiles is intimately linked to the calculation of speed profiles, this may also result in altitude being stepped down during the construction of the aircraft's trajectory, which is not desirable in the context of flight optimization.

Lastly, when automatic guidance is used, a lateral discontinuity that results in an overly steep segment may result in vertical guidance in the form of a ‘dive’ in order to better follow the pronounced slope of this profile. This translates into a more or less substantial increase in speed. When descending, and, more specifically, when approaching, it is not desirable for an aircraft to accelerate.

### SUMMARY OF THE INVENTION

The present invention aims to propose a calculation of a flight distance over a segment of discontinuity. This distance may thus be taken into account when calculating the trajectory of the aircraft such that it becomes more consistent in terms of predictions and energy dissipation actually experienced by the aircraft. This addresses the aforementioned disadvantages of the prior art and, in particular, to avoid unfounded alerts, premature extension of actuators, and over-steep descents.

To this end, the invention relates to a method for determining a flight distance of an aircraft over a segment of discontinuity of a trajectory portion of the aircraft, said portion further comprising two frame segments on either side of the segment of discontinuity, the segment of discontinuity comprising a lateral discontinuity, each frame segment being continuous.

The method comprises the following steps:
determining an altitude of entry to said trajectory portion and an altitude of exit from said trajectory portion;
discretizing an altitude interval delimited by the altitude of entry and the altitude of exit into a plurality of elementary intervals, each elementary interval being defined by using an elementary step;
for each elementary interval, determining an elementary slope of the aircraft;
determining the flight distance over the segment of discontinuity based on a direct distance between the frame segments, elementary slopes, elementary steps and the total extent of said trajectory portion in which the extent of the segment of discontinuity is substituted by the direct distance between the frame segments.

According to other advantageous aspects of the invention, the method for determining a flight distance comprises one or more of the following features, considered alone or according to all technically possible combinations:
the flight distance over the segment of discontinuity is determined according to the following expression:

$${d}_{v} = {d}_{d i r} + max ( 0 , {\sum }_{i} \frac{Δ {H}_{i}}{tan ( {FPA}_{i} )} - x )$$

where:

d_{dir} is the direct distance between the frame segments;

x is the total extent of said geometric trajectory portion;

FPAᵢ is the elementary slope over an elementary interval i; and

ΔHᵢ is the step defining the elementary interval i;
the flight distance over the segment of discontinuity is determined based on the direct distance between the frame segments, the elementary steps, the total extent of said trajectory portion in which the extent of the segment of discontinuity is substituted by the direct distance between the frame segments, and a retained slope;

the retained slope corresponding to one of the elements chosen from the group including:
an equivalent resultant slope determined by using the set of elementary slopes;
a slope of lowest absolute value among the set of elementary slopes;
each elementary step is defined to be less than or equal to a predetermined parameter defining the calculation precision of the flight distance over the segment of discontinuity;
each elementary slope is determined for the corresponding elementary interval based on the performance of the aircraft over this elementary interval;
when the variation in altitude over said trajectory portion is zero or when there is no altitude constraint imposing a particular slope, but a speed constraint exists with a lower limit on said trajectory portion, the flight distance over the segment of discontinuity is determined based on a speed of the aircraft over each elementary interval;
the segment of discontinuity corresponds to a manual termination leg.

The present invention also relates to a method for determining a trajectory of an aircraft, comprising, for the or each segment of discontinuity, implementing a method for determining a flight distance over this segment of discontinuity, as previously defined.

According to other advantageous aspects of the invention, the method for determining a trajectory of an aircraft comprises the following steps:
determining a reference profile along a lateral trajectory precalculated based on a plurality of speed and/or altitude constraints, wherein the precalculated lateral trajectory comprises a plurality of segments, wherein the determining step comprises:
   searching in the precalculated lateral trajectory for at least one segment of discontinuity between two segments (‘frame segments’), wherein the segment of discontinuity comprises a lateral discontinuity;
   for the or each segment of discontinuity, determining a required distance corresponding to the flight distance determined for this segment of discontinuity; and
   integrating the/each required distance into the reference profile;
determining vertical predictions related to a vertical trajectory of the aircraft based on the reference profile;
determining a lateral trajectory based on the vertical projections, comprising, for each segment of discontinuity, determining a substitution segment connecting the two corresponding frame segments in a continuous manner, wherein the spatial extent of the/each substitution segment is determined as a function of the required distance determined for the corresponding segment of discontinuity.

The invention also relates to a computer program product including software instructions which, when implemented by computer equipment, carry out the method for determining a trajectory of an aircraft, as defined supra.

The invention also concerns a module for calculating a trajectory of an aircraft, comprising technical means configured to carry out the method for determining a trajectory of an aircraft, as defined supra.

### BRIEF DESCRIPTION OF THE DRAWINGS

These features and advantages of the invention will appear upon reading the following description, provided solely as a non-limiting example, and done in reference to the appended drawings, in which:

FIG. 1 is a schematic view illustrating the implementation of the calculation of predictions according to methods of the state of the art;

FIG. 2 is a schematic view of a module for determining a trajectory of an aircraft according to the invention;

FIG. 3 is a flowchart of a method for determining a trajectory according to the invention, the method being carried out by the determining system of FIG. 2;

FIGS. 4 to 11 are views illustrating the implementation of various steps of the method of FIG. 3; and

FIG. 12 is a flowchart of a method for determining a flight distance over a segment of discontinuity according to the invention, this method being carried out by the determination module of FIG. 2.

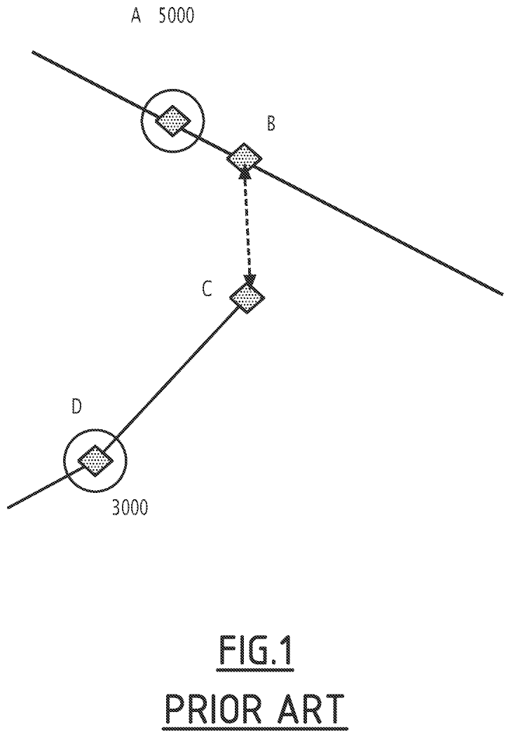

### DETAILED DESCRIPTION OF THE INVENTION

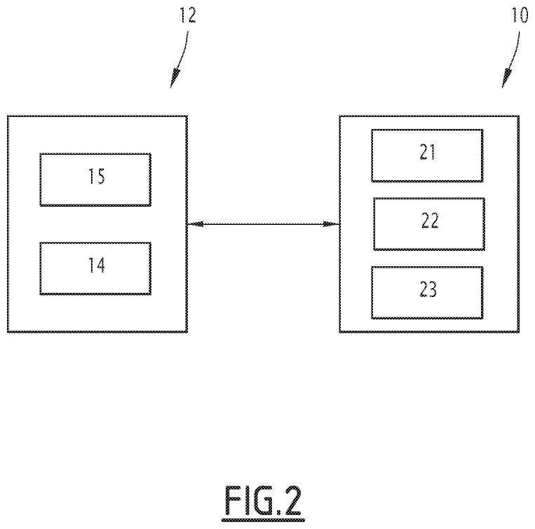

FIG. 2 shows a schematic view of a module 10 for determining a trajectory of an aircraft according to the invention.

‘Aircraft’ refers to any machine that can be controlled to fly, in particular in the terrestrial atmosphere, e.g. an airplane, in particular a commercial airliner, a helicopter, a drone, etc.

The aircraft can be controlled by a pilot from a cockpit of the aircraft or remotely.

In particular, the aircraft includes an FMS (flight management system), which allows for the construction of a trajectory of the aircraft based on a flight plan input into the system by the pilot. To this end, the FMS is provided with a user interface that allows the pilot to input the necessary information into the system and to obtain a visual representation of the calculations carried out by the system, e.g. the trajectory of the aircraft.

To this end, the man-machine interface of the FMS for example takes the form of a suitable keyboard and one or several suitable display screens.

In the exemplary embodiment of FIG. 2, the determination module 10 is connected to the FMS, which is then designated by reference 12 in this FIG. 2.

The determination module 10 is on board the aircraft or is remote therefrom. In the latter case, this determination module 10 is connected to the FMS via remote digital data transmission means, known in themselves.

Furthermore, the determination module 10 is able to receive data introduced by the pilot into the FMS 12 via the keyboard 14 of this FMS 12 and to display the results of its operation on the screen 15 of this FMS 12 or on any other screen of the cockpit of the aircraft, or on a remote screen.

In addition, according to one particular exemplary embodiment of the invention (not illustrated), the determination module 10 is able to receive data from a datalink with the ground.

According to the exemplary embodiment of FIG. 2, the determination module 10 assumes the form of a computer including an input unit 21, a processing unit 22 and an output unit 23.

Each of these units 21, 22, 23 for example at least partially assumes the form of software executed by the computer forming the module 10 in particular using a processor and a memory that are provided for this purpose in this computer.

According to another exemplary embodiment (not illustrated), the determination module 10 is integrated into the FMS 12 or into any other computer existing in the aircraft or into a remote computer. In this case, the units 21, 22, 23 at least partially assume the form of software executable by such a computer.

The input unit 21 is able to receive data from the FMS 12 and to transmit them to the processing unit 22.

The processing unit 22 is able to process these data as will be explained infra and to transmit a result of this processing to the output unit 23.

Lastly, the output unit 23 is able to transmit this result to the FMS 12 in order for example to display it on the screen 15 or on any other screen of the cockpit.

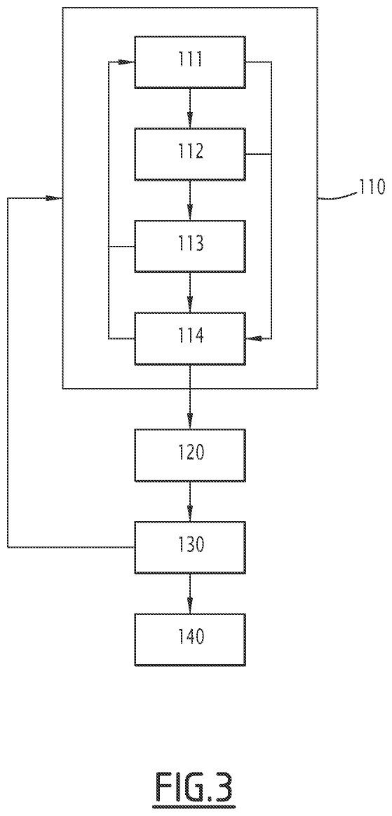

The method for determining the trajectory of the aircraft, implemented by the determination module 10, will now be explained in reference to FIG. 3, showing a block diagram of its steps. The trajectory calculated by this method in particular comprises a reference profile that will serve as a reference for the aircraft to perform its descent and its approach.

Advantageously, the method is implemented during the preparation of the flight by the pilots.

In this case, the pilots have a lateral trajectory precalculated based on a plurality of speed and/or altitude constraints from a flight plan.

Each constraint from the flight plan is associated with a waypoint of the trajectory of the aircraft on which it imposes at least one flight parameter of the aircraft. Such a constraint in particular corresponds to an altitude constraint or a speed constraint respectively defining at least an altitude value to be respected or a speed value to be respected.

Furthermore, as is known in itself, each constraint has a type of constraint that indicates how the value(s) defined by the constraint must be respected.

In particular, in the state of the art, the following types of constraint are known:
“AT” defining a single value that indicates that the corresponding flight parameter must be equal to this value;
“AT OR ABOVE” defining a single value that indicates that the corresponding flight parameter must be greater than or equal to this value;
“AT OR BELOW” defining a single value that indicates that the corresponding flight parameter must be less than or equal to this value;
“WINDOW” defining a two values that indicate that the corresponding flight parameter must be within an interval delimited by these two values.

According to another exemplary embodiment of the invention, the method is carried out during the flight of the aircraft from a pre-existing reference profile. This is in particular done when the reference profile must be modified for example following the acquisition of a new constraint or instruction. In this case, the precalculated trajectory is this existing reference profile.

Lastly, before carrying out the method, the input unit 21 acquires all the necessary data, and in particular the precalculated trajectory, to determine a reference profile to be followed by the aircraft.

Then, the input unit 21 sends all of the acquired data to the processing unit 22.

During the initial step 110, the processing unit 22 determines a reference profile to be followed by the aircraft from the precalculated trajectory. This therefore involves determining a new reference profile or updating a pre-existing reference profile.

In a manner known in itself, this determination is carried out by performing a back calculation made up of different operations:
calculation of the final approach;
calculation of the intermediate approach;
calculation of the geometric descent;
calculation of the optimized descent.

The calculation of the reference profile is carried out by the sub-steps 111-114, which are repeated in a loop starting from the beginning of the integration until the altitude and speed at the end of cruising are reached, or until the current position of the aircraft is reached. When the sub-steps 111-114 are first carried out, the starting point of the integration corresponds to the destination of the aircraft, given that the calculation is carried out in reverse.

In particular, in the sub-step 111, the processing unit 22 determines an intermediate endpoint allowing the reference profile being constructed to be delimited from the starting point of the integration for one iteration of the sub-steps 111-114.

According to the invention, this intermediate endpoint corresponds to the next altitude constraint that requires a change in slope, while allowing for compliance with all of the intermediate constraints on the geometric portion in question.

A constraint requiring a change in slope is generally referred to as a binding constraint.

In one exemplary embodiment, to this end, the processing unit 22 first carries out a back calculation of the geometric portion in question from the integration starting point to the next AT constraint, if any.

If the geometric portion thus formed complies with all of the intermediate constraints, the AT constraint will be the intermediate endpoint sought, and the processing unit 22 goes on to the next sub-step 112.

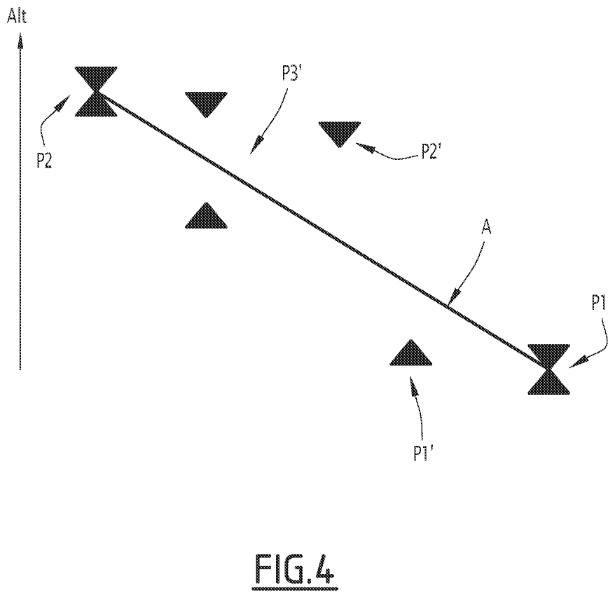

Such a case is shown in FIG. 4, in which the integration starting point is indicated by ‘P1’ and the AT altitude constraint by ‘P2’. Thus, it is clear that, in the case shown, the altitude profile A constructed between the points P1 and P2 complies with all of the intermediate constraints, i.e. the constraints P1′, P2′, and P3′.

Otherwise, i.e. if the geometric portion constructed between the integration starting point and the AT constraint does not comply with at least one intermediate constraint, the sub-step 111 is restarted, as in the previous case, at the integration starting point, but its target this time is the intermediate constraint that was missed. This constraint is then a type other than AT. The geometric portion in question in this new iteration of the sub-step 111 is then delimited by the integration starting point and the constraint missed in the previous calculation.

The sub-step 111 is thus repeated until the slope of the geometric portion obtained allows for compliance with all of the intermediate constraints included between the integration starting point and the target constraint, which will then be considered the intermediate endpoint sought.

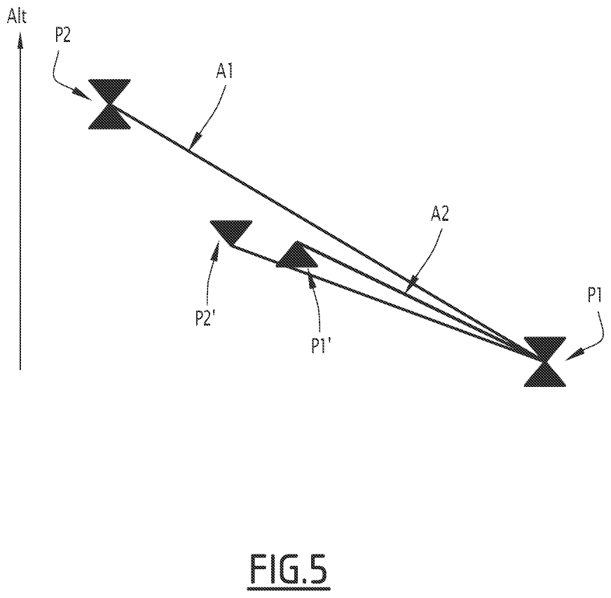

Such a case is shown in FIG. 5, in which the altitude profile A1 constructed between the integration starting point P1 and the next (AT) constraint P2 does not comply with the intermediate constraint P2′. The sub-step 111 is then repeated until the altitude profile A2 is obtained between the points P1 and P1′, which complies with all intermediate constraints.

If there is no binding constraint, the profile is calculated with a group of segments having a constant thrust up to the cruising level, the calculation considered optimal in terms of fuel consumption, and referred to as the ‘idle’ profile.

If this group of segments allows for compliance with all altitude constraints, there is no altitude constraint requiring a change in slope. In this case, the processing unit 22 searches for a speed constraint with a low limit (i.e. AT OR ABOVE, AT, or WINDOW) that would be missed. If such a speed constraint is found, it is considered the intermediate endpoint that is sought. Otherwise, the processing unit 22 moves directly to the step 130, which is explained in detail infra.

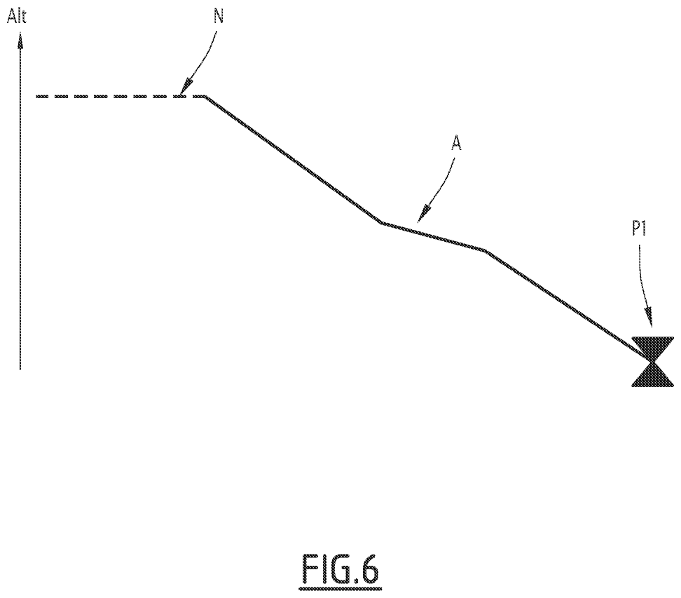

This case is shown in FIG. 6, in which the altitude profile A constructed between the integration starting point P1 and the cruising level N satisfies all intermediate constraints between these points.

If the group of segments having a constant thrust does not allow for compliance with at least one intermediate altitude constraint, the sub-step 111 is restarted at the integration starting point, and its target this time is the constraint that was missed, which will then be a constraint other than an AT constraint. The step 111 is then repeated until the slope of the geometric portion obtained allows for compliance with all intermediate constraints between the integration starting point and the target constraint.

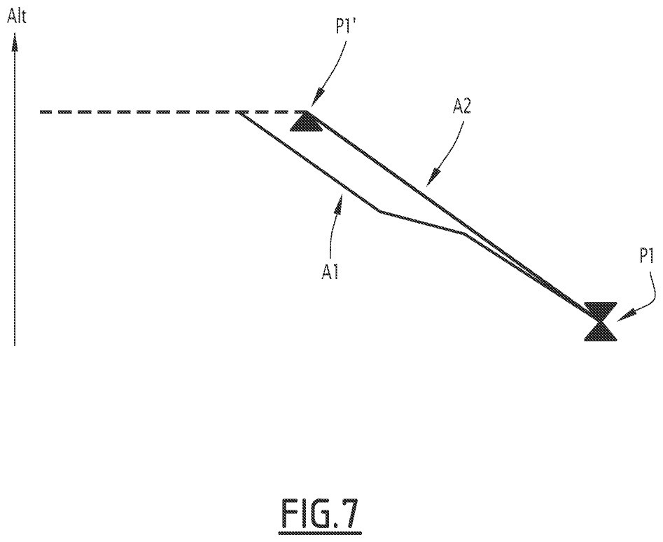

This case is shown in FIG. 7, in which the altitude profile A1 constructed between the integration starting point P1 and the cruising level point N does not allow for compliance with the intermediate altitude constraint P1′. The step 111 is then repeated, targeting the point P1′ and thus obtaining the profile A2. To the extent that this profile A2 allows for compliance with all intermediate points, the point P1′ is considered the intermediate endpoint sought.

In the following sub-step 112, the processing unit 22 searches the geometric portion delimited by the integration starting point and the intermediate endpoint determined in the sub-step 111 for a segment (‘segment of discontinuity’) comprising a lateral discontinuity. This lateral discontinuity may, for example, be a manual termination leg.

The segment of discontinuity is between two segments (‘frame segments’).

If there is at least one segment of discontinuity in the geometric portion, the processing unit 22 will go to the following sub-step 113. Otherwise, the processing unit 22 moves directly to the sub-step 114, which is described in detail infra.

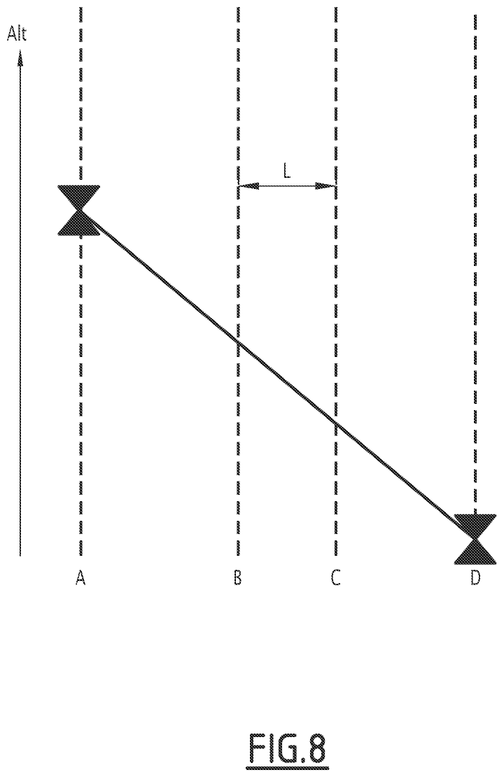

In the example of FIG. 8, a manual termination leg L is determined between the points B and C. The segment BC is then a discontinuity segment. Additionally, in this example, the point D corresponds to the integration starting point, and the point A corresponds to the intermediate endpoint determined at the end of the sub-step 111.

In the sub-step 113, for the segment of discontinuity identified, the processing unit 22 determines a required distance d_{req} corresponding to a minimum flight distance over the segment of discontinuity to ensure sufficient energy dissipation for compliance with upstream, intermediate, and downstream constraints, i.e. at the waypoints A, B, C, and D in the examples illustrated.

The energy dissipation depends on whether the configuration of the aircraft allows for the energy to be dissipated. This configuration is defined, in particular, by the position of the air brakes of the aircraft, its slats and flaps, or its landing gear.

According to the invention, the required distance d_{req} corresponds to a flight distance over the corresponding segment of discontinuity that is determined by carrying out the method for determining a flight distance according to the invention. This method will be explained in detail infra.

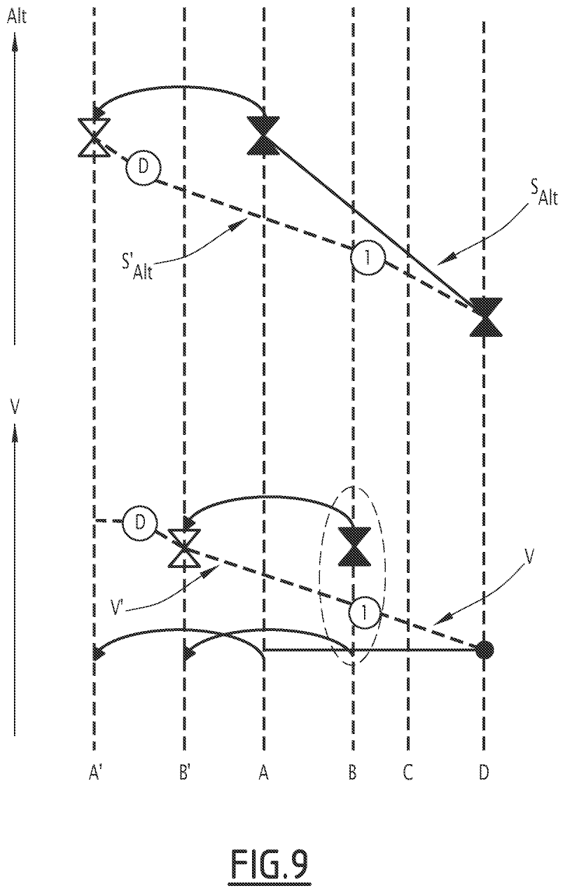

FIG. 9 shows the execution of the sub-step 113 in the example of FIG. 8.

In particular, FIG. 9 shows the new altitude S_{Alt}′ and speed V′ profiles obtained by extending the lateral discontinuity BC following the calculation of the required distance d_{req}. The new distance BC, which is represented in FIG. 9 by the distance B′C, then corresponds to the required distance d_{reg} calculated. The new geometric portion AD is thus also extended, and corresponds to the portion A′D in the example in FIG. 9.

In the final sub-step 114, the processing unit 22 integrates the required distance d_{req} determined in the geometric portion in question of the reference profile, and designates the intermediate endpoint as a new integration starting point.

If this new integration starting point corresponds to the starting point of the aircraft or its current position, the construction of the reference profile is complete, and the processing unit 22 goes on to the following step 120. Otherwise, the processing unit 22 moves on to the step 111 with this new integration starting point.

In the step 120, the processing unit 22 determines vertical predictions related to a vertical trajectory of the aircraft based on the reference profile.

In particular, these predictions concern the speed of the aircraft, the flight time, the position, and the amount of fuel remaining, and are determined according to known-art methods.

In the following step 130, the processing unit 22 determines a lateral trajectory based on the vertical predictions.

In particular, this step comprises, for the/each segment of discontinuity, determining a substitution segment, with the spatial extent of the substitution segment being determined as a function of the required distance determined previously.

To this end, the processing unit 22 first determines a deselection point of the/each segment of discontinuity as a function of the required distance dreq corresponding to this segment and of the direct distance d_{dir} between the framework segments corresponding to this segment of discontinuity, that is to say, the distance between the ends of these frame segments that are adjacent to the segment of discontinuity.

Each deselection point is defined by a predicted distance d₁, which must be flown over the segment of discontinuity with the course procedurally encoded in the case of the manual termination leg or, otherwise, with the course of the leg preceding the lateral discontinuity in the flight plan.

In a first exemplary embodiment of this step 130, the predicted distance d₁ is determined according to the following expression:

$${d}_{1} = \frac{{{d}_{r e q}}^{2} - {{d}_{dir}}^{2}}{2 \cdot ( {d}_{r e q} - {d}_{dir} \cdot cos ( θ ) )}$$

where θ is the angle formed between the two corresponding frame segments.

In this case, the spatial extent of the substitution segment without taking into account the extent of the transitions at its ends is equal to the required distance d_{req}.

If the aircraft is required to follow a course other than the one initially planned, the predicted distance d₁ is determined according to the following expression:

$${d}_{1} = \frac{{{d}_{r e q}}^{2} - {{d}_{dir}}^{2}}{2 \cdot ( {d}_{r e q} - {d}_{dir} \cdot cos ( {θ}^{′} ) )}$$

where θ′ is the angle formed between the new course and the frame segment following the segment of discontinuity.

Then, the processing unit 22 determines the transition at the deselection point of the corresponding discontinuity segment and the point of arrival at the frame segment following this discontinuity segment.

These transitions are determined depending on the type of transition desired (fly-by or overfly) and the type of alignment required by the frame segment following the corresponding discontinuity segment.

These transitions are determined, e.g., using the methods set forth in FR 3 064 351 A1.

In a second exemplary embodiment, the predicted distance dl is determined such that the total length of the trajectory, including the transitions, is equal to the required distance d_{req}.

In this case, the predicted distance d₁ is determined according to formulae analogous to those set forth supra, but taking into account the known values of the turning radius and the change of course determined by the corresponding transitions.

In the following step 140, the processing unit 22 transmits the trajectory determined to the output unit 23, which transmits it to on-board systems using the trajectory.

In particular, in this step 140, the processing unit 22 transmits the trajectory determined to a display in the cockpit of the aircraft, in particular to the vertical display and/or the navigation display.

In one exemplary embodiment of the invention, such a screen shows the lateral trajectory of the aircraft with lateral discontinuities caused by the lateral discontinuities in the flight plan.

Advantageously, in this case, the screen showing the lateral trajectory (navigation display) also shows a symbol representing the deselection point for the/each segment of discontinuity.

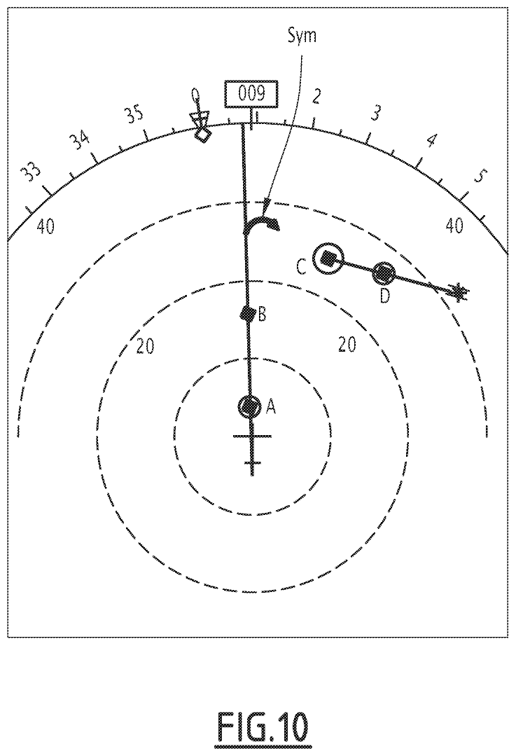

An example of such a display is shown in FIG. 10.

Indeed, as shown in FIG. 10, a lateral discontinuity of the lateral trajectory of the aircraft is defined between the points B and C, and the symbol Sym indicates the deselection point of the corresponding manual termination leg.

In one variant, the lateral trajectory and/or the vertical trajectory is/are continuously shown on the corresponding display. In this case, the segment of the trajectory corresponding to each lateral discontinuity is shown specifically, thus allowing it to be distinguished from the other segments of the trajectory. Thus, for example, such a segment is shown by a dashed line.

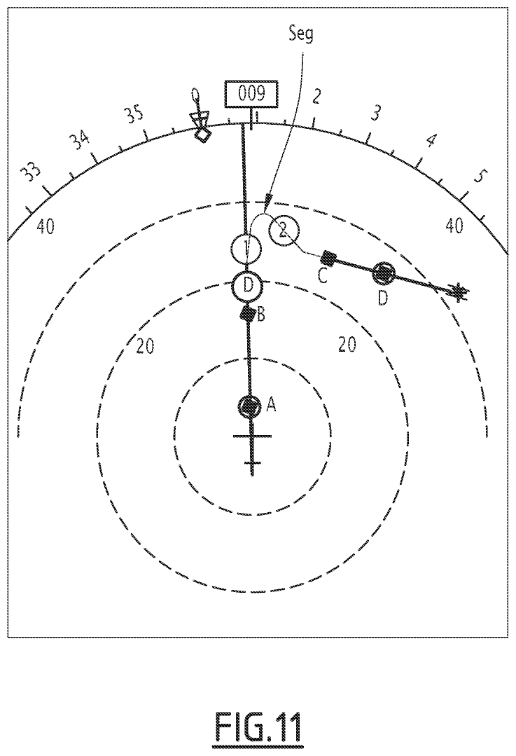

In the example of FIG. 11, the lateral segment BC constructed in the step 130 is shown by a dashed line.

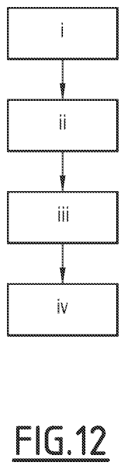

The method for determining a flight distance over a segment of discontinuity will now be explained in reference to FIG. 12, showing a flowchart of its steps.

In particular, as explained supra, this method is carried out in particular by the processing unit 22 of the module 10 upon each iteration of steps 111-114 when it is necessary to determine the required distance d_{req} for a segment of discontinuity. Thus, the flight distance dᵥ over the corresponding segment of discontinuity determined according to this method will be likened to the required distance d_{req} when the method described supra is carried out.

It should also be noted that the method for determining a flight distance over a segment of discontinuity may be carried out independently of the method for determining a trajectory described supra. This is for example the case when the trajectory of the aircraft is precalculated by any other available means and when it is necessary to determine a flight distance over each segment of discontinuity comprised in this trajectory while satisfying the energy constraints of this trajectory.

Before carrying out the method for determining a flight distance dᵥ over a segment of discontinuity, it is therefore considered that a trajectory portion including a segment of discontinuity is provided. This segment of discontinuity is positioned between two frame segments.

When this method is carried out during the sub-step 113 of the method for determining the trajectory, this trajectory portion is therefore the one determined between the integration starting point and the intermediate endpoint during the sub-step 112.

When this method is carried out independently of the method described supra, the trajectory portion considered may correspond to any other portion including respected speed and altitude constraints.

During an initial step (i) of the method, the processing unit 22 determines an altitude of entry h₀ and an altitude of exit h_{f} relative to the considered trajectory portion.

During the following step (ii), the processing unit 22 discretizes the interval [h₀, h_{f}] in order to obtain a plurality of elementary intervals [hᵢ, hᵢ₊₁]. Each elementary interval is obtained by using an elementary step αHᵢ relative to this interval.

In particular, the elementary intervals are determined as follows:

hᵢ₊ᵢ=hᵢ+αHᵢ,

where

hᵢ and hᵢ₊₁ are the altitudes delimiting the elementary interval i; and

$$Δ {H}_{i} = min ( {h}_{CSTR x} - {h}_{i} , \frac{( {CAS}_{p} - {CAS}_{i} )}{{\frac{dCAS}{dh}}_{TGT}} , Δ {H}_{MAX} , {h}_{f} - {h}_{i} )$$

where

CASₚ is the speed of the next predictable change in the configuration of the aircraft or flight phase (S/F, L/G, A/I, DECEL, etc.), this speed being predefined and known through an aircraft performance database;

CASᵢ is the speed of the aircraft at the altitude hᵢ;

αH_{MAX} is the maximum discretization value at altitude characterizing the precision of the calculations, this value for example being equal to 2000 ft by default;

h_{CSTR x} is the altitude at the speed constraint CAS_{CSTR+} or CAS_{CSTR-[i,CSTR+[,} defined below;

$${\frac{dCAS}{dh}}_{TGT}$$

is the variation in the target speed, in kts/ft, depending on the flight phase, and defined such that

on descent:

$${\frac{dCAS}{dh}}_{TGT} = max ( S , min ( \frac{{CAS}_{CSTR +} - {CAS}_{i}}{{h}_{CSTR +} - {h}_{i}} , \frac{{CAS}_{CSTR - [ i , CSTR + [} - {CAS}_{i}}{{h}_{CSTR - [ i , CSTR + [} - {h}_{i}} ) ) ,$$

and on approach:

$${\frac{dCAS}{dh}}_{TGT} = min ( max ( S , \frac{{CAS}_{CSTR +} - {CAS}_{i}}{{h}_{CSTR +} - {h}_{i}} ) , \frac{{CAS}_{CSTR - [ i , CSTR + [} - {CAS}_{i}}{{h}_{CSTR - [ i , CSTR + [} - {h}_{i}} ) ,$$

where

CAS_{CSTR+} is the next speed constraint (in reverse) with a lower limit (of the AT OR ABOVE or AT or WINDOW type), if one exists. This is the closest constraint CAS_{CSTR+} from the integration starting point over the entire geometric portion between hᵢ and h_{f};

CAS_{CSTR-[i,CSTR+[} is the next speed constraint (in reverse) with an upper limit (of the AT OR BELOW or AT or WINDOW type), if one exists, limiting the reverse acceleration from CASᵢ to CAS_{CSTR+}, based on a geometric interpolation;

h_{CSTR x} is the altitude at the considered speed constraint, obtained by interpolating the calculation of the geometric slope between hᵢ and h_{f}, considering a direct distance over the corresponding manual termination leg;

S is the configurable target minimum rate of acceleration, which is for example equal to 0 on descent and to 25/1000 kts/ft on approach.

Thus, the expression for the altitude hᵢ₊₁ takes the following form:

$${h}_{i + 1} = min ( {h}_{i} + min ( \frac{( C A {S}_{p} - C A {S}_{i} )}{{\frac{dCAS}{dh}}_{TGT}} , Δ {H}_{MAX} ) , {h}_{CSTR x} , {h}_{f} ) .$$

Then, during the following step (iii), the processing unit 22 determines an elementary slope FPAᵢ for each elementary interval i.

Over each elementary interval i, the corresponding elementary slope FPAᵢ is obtained by using a service pre-existing in the state of the art and allowing a slope to be calculated according to certain criteria. In particular, this service, which is based on performance data of the aircraft, depends on the following parameters:

$${FPA}_{i} = f ( Δ ISA , m , h , S / F , T , {W}_{x} , {W}_{y} , CAS , {\frac{dCAS}{dh}}_{TGT} , {n}_{EI} , ε , Δ , {x}_{CG} , A / B , A / I , L / G , c , {FPA}_{0} ) ,$$

where:

ΔISA is the temperature difference from the international standard atmosphere (ISA);

m is the mass of the aircraft;

h is the altitude of the aircraft;

S/F is the aerodynamic configuration of the aircraft (“slats/flaps”);

T is the engine thrust of the aircraft;

Wₓ is the headwind;

W_{y} is the crosswind;

CAS is the calibrated air speed of the aircraft;

$${\frac{dCAS}{dh}}_{TGT}$$

is the variation in target CAS as a function of altitude in kts/ft;

n_{EI} is the number of failed engines;

ε is the margin applied to the constant thrust;

Δ is the margin applied to the thrust in descent;

x_{CG} is the position of the center of gravity of the aircraft;

A/B is a parameter defining the position of the air brakes;

A/I is a parameter defining the status of the anti-ice system;

L/G is a parameter defining the position of the landing gear: retracted or extended;

c is the curve equal to the reciprocal of the turning radius;

FPA₀ is ground slope at the start of the calculation.

Then, during the following step (iv), the processing unit 22 determines the flight distance dᵥ over the segment of discontinuity based on a direct distance between the frame segments d_{dir}, elementary slopes FPAᵢ, elementary steps ΔHᵢ and the total extent of said trajectory portion in which the extent of the segment of discontinuity is substituted by the direct distance between the frame segments.

In particular, this flight distance dᵥ is determined according to the following expression:

$${d}_{v} = {d}_{d i r} + max ( 0 , {\sum }_{i} \frac{Δ {H}_{i}}{tan ( {FPA}_{i} )} - x )$$

where:

d_{dir} is the direct distance between the corresponding frame segments, i.e., the distance BC in the example of FIG. 8; and

x is said total extent of the geometric portion in question, i.e. the distance AD in the example of FIG. 8, assuming that the extent of the segment of discontinuity is substituted by the direct distance (d_{dir}) between the frame segments.

In a variant, to calculate the distance dᵥ, it is possible to use only a single slope, called retained slope.

This retained slope retained may have an equivalent resultant slope, i.e. a single slope equivalent to the overall variation in altitude and distance caused by all of the elementary slopes FPAᵢ or the most penalizing slope, i.e., a slope of lowest absolute value among the plurality of elementary slopes FPAᵢ.

In this last case, to avoid locally creating a slope that is too steep, the required distance d_{req} is calculated according to the following expression instead of the previous expression:

$${d}_{v} = {d}_{d i r} + max ( 0 , \frac{{Σ}_{i} Δ {H}_{i}}{tan ( max {FPA}_{i} )} - x ) .$$

Advantageously, according to the invention, during step (iv) the distance to be flown dᵥ is calculated differently in two specific cases.

The first specific case is the case where the altitude variation (ΔH or ΔHᵢ) over the geometric portion in question is zero but where the speed is constrained by a lower limit. In this case, the slope retained for this portion is also zero and the trajectory is calculated in reverse acceleration step downs.

In the second specific case, there is no altitude constraint imposing a particular slope, but there is a speed constraint with a lower limit upstream of the initial point of the portion with constant thrust in question; this is called “idle.” In this case, the reference profile is calculated in “energy sharing” mode, i.e., using a constant minimal thrust of the aircraft with a constant ratio of kinetic energy dissipation to potential energy dissipation.

In these two particular cases, the required distance d, is determined according to the following expression.

$${d}_{v} = {d}_{d i r} + max ( 0 , ( {\sum }_{{CAS}_{0}}^{{CAS}_{CSTR +}} ( \frac{C A {S}_{i + 1} - C A {S}_{i}}{{\frac{d C A S}{d x}}_{i}} ) - y ) - x )$$

x is the total distance of the considered portion (considering a direct distance over the segment of discontinuity), which is reduced to the distance between the beginning of the segment of discontinuity (e.g., the beginning of the manual termination leg) and the end of the portion in question, this value then corresponding to the distance AC in the example of FIG. 8;

y is the distance traveled at constant speed if it exists due to a speed constraint CAS_{CSTR-} upstream (in reverse) of the segment of discontinuity, such that:

$$y = max ( 0 , {\sum }_{{CAS}_{0}}^{{CAS}_{CSTR +}} ( \frac{C A {S}_{i + 1} - C A {S}_{i}}{{\frac{d C A S}{d x}}_{i}} ) - \frac{C A {S}_{CSTR -} - C A {S}_{0}}{{\frac{d C A S}{d x}}_{0}} - ( {x}_{CSTR +} - {x}_{CSTR -} ) ) ;$$

CAS_{CSTR+} is a speed constraint requiring a deceleration rate (in reverse) going beyond the discontinuity of the corresponding discontinuity segment;

d_{dir} is the direct distance between the corresponding frame segments;

CAS₀ is the speed at the start (in reverse) of the discontinuity segment;

CAS₊ is the lower limit of the speed constraint;

CASᵢ₊ᵢ is the speed at the lower limit limited to the next foreseeable change in the configuration of the aircraft or the flight phase (S/F, L/G, A/I, DECEL, etc.) affecting performance;

CASᵢ is the speed of the aircraft at point i;

$${\frac{d C A S}{d x}}_{i}$$

refers to incremental variations in speed for the first specific case or in ‘energy sharing mode’ for the second specific case in kts/NM over the corresponding discretized portion; these variations are estimated using the performance model allowing for calculation of the deceleration capacity given the state of the aircraft and the meteorological data.

One can then see that the present invention has a certain number of advantages.

In fact, the invention allows a flight distance to be calculated over a segment of discontinuity of an aircraft trajectory while respecting all of the energy constraints imposed on this trajectory.

The distance thus calculated may be used to build a more precise trajectory.

This trajectory allows for better energy management on the aircraft, in particular during descent, and for more reliable predictions. This, in turn, allows for segments that are too steep and excessive speeds to be avoided while the aircraft is in flight. This also allows for unfounded alerts to be avoided during flight and/or flight planning.

1. A method for determining a flight distance of an aircraft over a segment of discontinuity of a trajectory portion of the aircraft, said portion further comprising two frame segments on either side of the segment of discontinuity, the segment of discontinuity comprising a lateral discontinuity, each frame segment being continuous; the method comprising the following steps:
determining an altitude of entry to said trajectory portion and an altitude of exit from said trajectory portion;
discretizing an altitude interval delimited by the altitude of entry and the altitude of exit into a plurality of elementary intervals, each elementary interval being defined by using an elementary step;
for each elementary interval, determining an elementary slope of the aircraft;
determining the flight distance over the segment of discontinuity based on a direct distance between the frame segments, elementary slopes, elementary steps and the total extent of said trajectory portion in which the extent of the segment of discontinuity is substituted by the direct distance between the frame segments.

2. The method according to claim 1, wherein the flight distance over the segment of discontinuity is determined according to the following expression:
$${d}_{v} = {d}_{d i r} + max ( 0 , {\sum }_{i} \frac{Δ {H}_{i}}{tan ( {FPA}_{i} )} - x )$$
where:
d_{dir} is the direct distance between the frame segments;
x is said total extent;
FPAᵢ is the elementary slope over an elementary interval i; and
ΔHᵢ is the step defining the elementary interval i.

3. The method according to claim 1, wherein the flight distance over the segment of discontinuity is determined based on the direct distance between the frame segments, the elementary steps, the total extent of said trajectory portion in which the extent of the segment of discontinuity is substituted by the direct distance between the frame segments, and a retained slope;
the retained slope corresponding to one of the elements chosen from the group including:
an equivalent resultant slope determined by using the set of elementary slopes;
a slope of lowest absolute value among the set of elementary slopes.

4. The method according to claim 1, wherein each elementary step is defined to be less than or equal to a predetermined parameter defining the calculation precision of the flight distance over the segment of discontinuity.

5. The method according to claim 1, wherein each elementary slope is determined for the corresponding elementary interval based on the performance of the aircraft over this elementary interval.

6. The method according to claim 1, wherein when the variation in altitude over said trajectory portion is zero or when there is no altitude constraint imposing a particular slope, but a speed constraint exists with a lower limit on said trajectory portion, the flight distance over the segment of discontinuity is determined based on a speed of the aircraft over each elementary interval.

7. The method according to claim 1, wherein the segment of discontinuity corresponds to a manual termination leg.

8. A method for determining a trajectory of an aircraft, comprising, for the or each segment of discontinuity, implementing a method for determining a flight distance over this segment of discontinuity, according to claim 1.

9. The method according to claim 8, comprising the following steps:
determining a reference profile along a lateral trajectory precalculated based on a plurality of speed or altitude constraints, wherein the precalculated lateral trajectory comprises a plurality of segments, wherein the determining step comprises:
searching in the precalculated lateral trajectory for at least one segment of discontinuity between two segments (‘frame segments’), wherein the segment of discontinuity comprises a lateral discontinuity;
for the or each segment of discontinuity, determining a required distance corresponding to the flight distance determined for this segment of discontinuity; and
integrating the/each required distance into the reference profile;
determining vertical predictions related to a vertical trajectory of the aircraft based on the reference profile;
determining a lateral trajectory based on the vertical projections, comprising, for each segment of discontinuity, determining a substitution segment connecting the two corresponding frame segments in a continuous manner, wherein the spatial extent of the/each substitution segment is determined as a function of the required distance determined for the corresponding segment of discontinuity.

10. A computer program product comprising software instructions which, when implemented by a piece of computer equipment, carry out the method according to claim 8.

11. A module for determining a trajectory of an aircraft, comprising technical means configured to carry out the method according to claim 8.
